(19) United States
(12) Patent Application Publication
(10) Pub. No.: US 2026/0112520 A1
(43) Pub. Date: Apr. 23, 2026

(54) HIGH VOLTAGE SUBMARINE CABLE SYSTEMS

(71) Applicant: Chevron U.S.A. Inc., San Ramon, CA (US)

(72) Inventors: Masoud HAJIAGHAJANI, Houston, TX (US); Gregory Joseph Clement, Sugar Land, TX (US)

(21) Appl. No.: 18/411,629

(22) Filed: Jan. 12, 2024

Related U.S. Application Data
(63) Continuation-in-part of application No. 17/382,644, filed on Jul. 22, 2021, now Pat. No. 12,030,597.

(51) Int. Cl. H01B 7/14; H01B 3/44; H01B 7/04; H01B 7/28; H02G 9/12; H02J 3/36; H02J 3/38; H02J 13/00

(52) U.S. Cl. CPC H01B 7/14; H01B 3/441; H01B 7/045; H01B 7/28; H02G 9/12; H02J 3/36; H02J 3/381; H02J 13/333; H02J 2101/20

(57) ABSTRACT

A system for transmission of power offshore comprises two or more power stations operably connected with a high voltage cable system. The high voltage cable system may comprise a dynamic, dry or wet type high voltage submarine cable of varying length configured to transmit at least about 100 megawatts of power. In some cases the dynamic, dry or wet type high voltage submarine cable comprises a first end connected to an offshore power station and second end connected to a static submarine cable system which is connected to an onshore power station. The systems may facilitate transmission of power for applications such as compressing and/or pumping subsea natural gas in deep water.

### CROSS REFERENCE TO RELATED APPLICATION

This application is a Continuation-in-Part of pending U.S. patent application Ser. No. 17/382,644, filed on Jul. 22, 2021, the entirety of which is incorporated herein by reference.

### FIELD OF THE INVENTION

The present inventions are directed to high voltage submarine cable systems for use in, for example, power transmission offshore and/or tiebacks to onshore power generation including, for example, renewable power generation from solar, wind, or wave.

### BACKGROUND AND SUMMARY

There is often a desire to transmit large amounts of power (in some cases >45 or >100 MW) from shore to a floater or from a floater to another floater to support offshore projects such as compression and pumping of natural gas, hydrocarbon exploration, hydrocarbon recovery, and the like. Unfortunately, conventional methods of such power transmission are often limited to smaller amounts of power, unreliable, and/or expensive due to multiple submarine cables being required. What is needed are new systems that can reliably transmit large amounts of power over long distances in water depths of greater than 400 meters in a cost-effective manner. Advantageously, the systems described herein meet the aforementioned needs and more.

In one embodiment, the application pertains to a system for transmission of power offshore comprising: (1) an offshore power distribution station; (2) a power transmission station; and (3) high voltage cable system operably connected to (1) and (2). Unlike prior art systems that often rely on wet type submarine cables, the instant high voltage cable system comprises a dynamic, dry or wet type high voltage submarine cable configured to transmit at least about 100 megawatts of power.

In another embodiment the application pertains to a system for transmission of power offshore comprising: (1) an offshore power distribution station; (2) an onshore power transmission station; and (3) high voltage cable system operably connected to (1) and (2). In this embodiment the high voltage cable system comprises a dynamic, dry or wet type high voltage submarine cable configured to transmit at least about 100 megawatts of power and wherein said dynamic, dry or wet type high voltage submarine cable comprises a first end and a second end wherein said first end is connected to the offshore power station. A static submarine cable system is operably connected to (1) the second end of the dynamic, dry or wet type high voltage submarine cable and (2) a high voltage land cable which is connected to the onshore power station.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 shows a cross-section of a representative high voltage submarine power cable according to an example embodiment.

FIG. 2 shows a representative application of a system for transmission of power offshore according to an example embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

The systems described herein may be used to transmit AC or DC power from one power station to another. As used herein, a power station may include generating stations or receiving stations located onshore or offshore. A receiving station may include a receiving load or a power distribution hub. In some embodiments, the power stations may be generating stations, e.g., power plants, located offshore or more preferably onshore. In some embodiments the power plants may generate renewable energy or clean energy, e.g., from hydropower, wind, solar, wave, biomass or clean burning natural gas or liquid natural gas.

Power may be transmitted from, for example, an onshore power generating station to one or more receiving stations such as an offshore power station such as a semisubmersible power and control distribution floater. As another example, power may be transmitted from an offshore power generating station, such as a conventional gas turbine power generator, a combined cycle power generator, a floating wind farm, or other forms of offshore power generators providing power to one or more receiving loads or power distribution hubs. Advantageously, in some embodiments, using the systems described herein may be used to transmit power from a receiving power distribution hub to another receiving power distribution hub.

In some embodiments the power station may comprise transformers to step up or down the voltage. For offshore power stations such transformers may be above the water or beneath the water. The power station may comprise other components such as a switch gear, reactive power compensation equipment (e.g., a shunt reactor or static var compensator), a frequency converter, an adjustable speed drive, a wet or dry mate connector, electrical and/or control/communication interfaces, and/or any combination thereof. In some embodiments the power station may be operably linked to equipment in need of power such as pumps, compressors, motors, charging stations, etc.

In some embodiments a high voltage cable system is employed to operably connect an offshore power station to a second, third, or even additional power stations. The high voltage cable system typically comprises a dynamic, dry or wet type high voltage submarine cable configured to transmit at least about 100 megawatts of power. In some embodiments the dynamic, dry or wet type high voltage submarine cable is operably connected to additional types of cable such as wet or dry, static or dynamic submarine cables, high voltage land cables, and the like. For example, the dynamic, dry or wet type high voltage submarine cable may be connected to a static submarine cable system comprised of one or more lengths of static submarine cable which static submarine cable system may in turn be operably connected to a high voltage land cable connected to an onshore power station. In some embodiments, one or more horizontal directionally drilled ducts may be used to surround at least a portion of the high voltage cable system. The aforementioned static submarine cables may include field joints but in many applications do not.

The specific dimensions and specification of the dynamic, dry or wet type high voltage submarine cable may vary depending upon the specific application (e.g., voltage, power, distance, and environmental conditions such as water depth, water motion, temperature, and other factors). As used herein “dry” submarine cables are those configured so that a cable insulation core is not exposed to water or moisture due to the presence of a metallic or any other form of water barrier sheath. As used herein “wet” submarine cables are those configured so that the cable insulation may be exposed to water or moisture penetration over time. Such wet type cables may include copper wire or tape screen that are not impervious to water and may include a non-metallic semiconductor for a conductor screen. The dynamic, dry or wet type high voltage submarine cable may include insulation comprising cross-linked polyethylene (XLPE) or ethylene propylene rubber (EPR).

The dynamic, dry or wet type high voltage submarine cable is configured to hang from a non-fixed platform such as an offshore semisubmersible power and control distribution floater. The dynamic, dry or wet type high voltage submarine cable used herein is typically configured to transmit at least about 45, or at least about 60, or at least about 85, or at least about 100 megawatts of power or more. The dynamic, dry or wet type high voltage submarine cable used herein is configured to operate at a maximum voltage of up to about 245 kV AC or +/−320 kV DC. The dry or wet type high voltage submarine cable used herein may be configured to be employed in water depths of up to about 3000 meters. Similarly, the dry or wet type high voltage submarine cable may have a conductor size (i.e., cross-sectional area) of up to 630 mm² for high voltage AC applications or up to 800 mm² for high voltage DC applications.

As described above, the dynamic, dry or wet type high voltage submarine cable may be connected to a static submarine cable system comprised of one or more lengths of static submarine cable which static submarine cable system may in turn be operably connected to a high voltage land cable connected to an onshore power station. The length, cross-sectional area, and type of static submarine cables in the static submarine cable system may vary depending upon the desired configuration, water depth, amount of power to be transmitted and other factors. One or more static cables in the static submarine cable system may be a dry or wet type comprised of the materials described above for the dynamic, dry or wet type cable. In some embodiments, the static submarine cable system may comprise a combination of wet and dry-type cables. The lengths of one or more static cables in the static submarine cable system vary widely.

### An Exemplary Embodiment of a High Voltage System

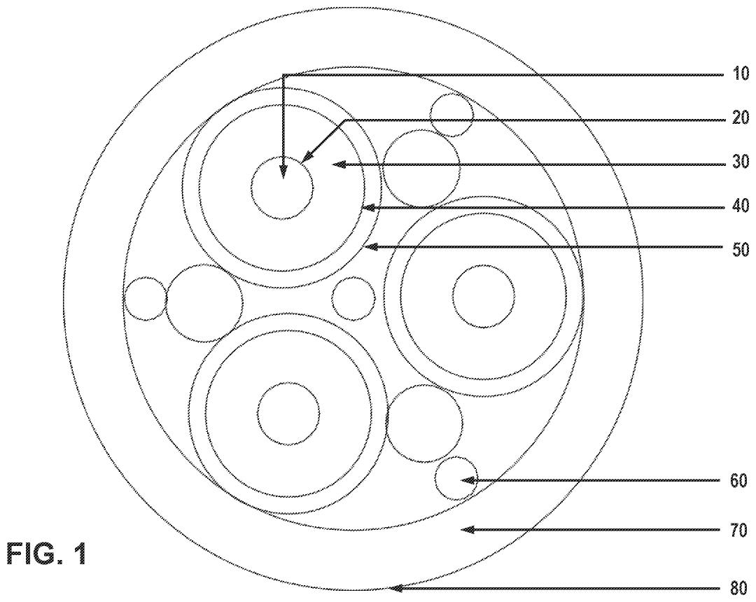

FIG. 1 shows a general construction of a submarine power cable that may be used herein wherein 10 is a conductor, 20 is a semiconductor, 30 is insulation, 40 is semiconductor, 50 is a metallic sheath/barrier, 60 is an optional optical fiber, 70 is armor, and 80 is outer sheath. Of course, the materials in the general construction may vary depending upon whether the cable is a dry design or wet design.

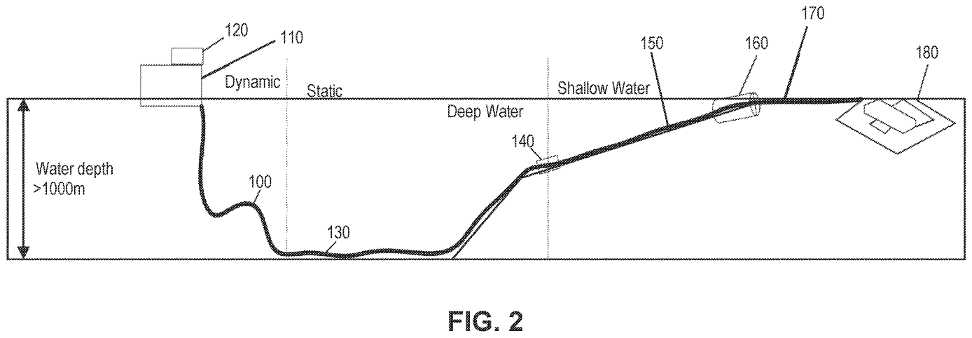

As described above, the systems of the present application can be configured in many different ways using various types of submarine cables. One exemplary embodiment of many different useful configurations is shown in FIG. 2. FIG. 2 shows an embodiment capable of delivering up to or over 100 MW of power at up to about 245 kV AC or +/−320 kV DC to a floating platform or semisubmersible 110 from an onshore power plant 180. A length of dynamic, dry or wet type high voltage submarine cable 100 is hung from the floating platform or semisubmersible 110 in water having a depth of up to 3000 meters. The floating platform or semisubmersible 110 may have a topside transformer (with or without reactive compensation units) 120. The floating platform 110 may be used as an interface to a broader hub of power generation, power transmission, or both. Additionally or alternatively, the floating platform 110 may be used like a field control station to supply power locally to, for example, a system or components such as, but not limited to, compressors boosting pumps, and charging stations.

The dynamic, dry or wet type high voltage submarine cable 100 is connected to deep water static submarine cable 130. Optional field joints such as 140 may be included if desired. A shallow water static submarine cable 150 is connected to the deep water static submarine cable 130. A horizontal directional drilling duct 160 may be employed near high voltage land cable 170 which may comprise up to three cables to connect to power plant 180. Advantageously, systems such as that described in FIG. 2 may offer tremendous advantages in cost-efficient high voltage power delivery to a network of onshore and/or offshore power generation or transmission including, for example, from a floating platform to an onshore, renewable power generation system. Advantageously, systems such as that described in FIG. 2 may also reduce offshore emissions and lower carbon intensity.

1. A system for transmission of power offshore comprising:
(1) an offshore power distribution station;
(2) a power transmission station; and
(3) a high voltage cable system operably connected to (1) and (2);
wherein said high voltage cable system comprises a dynamic, dry or wet type high voltage submarine cable configured to transmit at least about 100 megawatts of power;
wherein at least a portion of the dynamic, dry or wet type high voltage submarine cable is at a water depth of about 3000 meters.

2. The system of claim 1 wherein the dynamic, dry or wet type high voltage submarine cable is configured to operate at a maximum AC voltage up to about 245 kV.

3. The system of claim 1 wherein the dynamic, dry or wet type high voltage submarine cable is configured to operate at a maximum DC voltage up to about +/−320 kV.

4. The system of claim 1 wherein the offshore power distribution station comprises a field control station.

5. The system of claim 1 wherein the offshore power distribution station comprises a semisubmersible power and control distribution floater.

6. The system of claim 1 wherein the power transmission station comprises:
(1) an offshore semisubmersible power and control distribution floater; or
(2) an onshore or offshore power station.

7. The system of claim 6 wherein the power transmission station comprises an onshore or offshore power station and wherein the onshore or offshore power station is for generating renewable energy.

8. The system of claim 7 wherein the renewable energy is generated from wind, hydropower, solar, wave, or a combination thereof.

9. The system of claim 1 wherein the dynamic, dry or wet type high voltage submarine cable is a dry type high voltage submarine cable comprising a metallic or other form of water barrier.

10. The system of claim 1 wherein the dynamic, dry or wet type high voltage submarine cable comprises insulation comprising cross-linked polyethylene (XLPE) or ethylene propylene rubber (EPR).

11. The system of claim 1 wherein the power transmission station comprises an onshore power station and wherein the high voltage cable system further comprises a high voltage land cable.

12. The system of claim 1 further comprising a third power station wherein the third power station is offshore and operably connected the offshore power station or the second power station with a high voltage submarine cable.

13. (canceled)

14. A system for transmission of power offshore comprising:
(1) an offshore power distribution station;
(2) an onshore power transmission station; and
(3) high voltage cable system operably connected to (1) and (2);
wherein said high voltage cable system comprises:
a dynamic, dry or wet type high voltage submarine cable configured to transmit at least about 100 megawatts of power and wherein said dynamic, dry or wet type high voltage submarine cable comprises a first end and a second end wherein said first end is connected to the offshore power distribution station; and
a static submarine cable system operably connected to (1) the second end of the dynamic, dry or wet type high voltage submarine cable and (2) a high voltage land cable which is connected to the onshore power transmission station;
wherein at least a portion of the dynamic, dry or wet type high voltage submarine cable is at a water depth of about 3000 meters.

15. The system of claim 1 wherein the dynamic, dry or wet type high voltage submarine cable is configured to operate at a maximum AC voltage up to about 245 kV.

16. The system of claim 1 wherein the dynamic, dry or wet type high voltage submarine cable is configured to operate at a maximum DC voltage up to about +/−320 kV.

17. The system of claim 14 which further comprises horizontal directionally drilled ducts surrounding at least a portion of the high voltage cable system.

18. The system of claim 14 wherein the offshore power transmission station comprises a step-up transformer with or without reactive compensation units.

19. The system of claim 14 wherein the offshore power transmission station is operably connected a compressor, a booster pump, a charging station, or a combination thereof.

20. (canceled)
